(19) United States
(12) Patent Application Publication
(10) Pub. No.: US 2024/0035611 A1
(43) Pub. Date: Feb. 1, 2024

(54) DEVICE FOR TRANSLATION AND ROTATION OF SCREENS IN A TWO-DIMENSIONAL PLANE AND ITS USE

(71) Applicant: MANKIND NV, Wolvertem (BE)

(72) Inventor: Erik VAN DER BORGHT, Wolvertem (BE)

(21) Appl. No.: 18/257,235

(22) PCT Filed: Dec. 15, 2021
(86) PCT No.: PCT/IB2021/061773

§ 371 Date: Jun. 13, 2023

(30) Foreign Application Priority Data
Dec. 15, 2020 (BE) 2020/5926
Dec. 15, 2020 (BE) 2020/5927

(51) Int. Cl. F16M 11/08; F16M 11/18; F16M 11/20; G06F 3/14

(52) U.S. Cl. CPC F16M 11/08; F16M 11/18; F16M 11/2085; G06F 3/1446; G09G 2300/026

(57) ABSTRACT

The present invention relates to a device for translation and rotation of screens in a two-dimensional plane comprising a support structure to which a lying rail is attached and at least two carriages configured for moving along the lying rail in a translation direction parallel to the lying rail, wherein each carriage comprises a screen with a flat display surface, wherein the screen is rotatable about a rotary shaft perpendicular and centrally to the flat display surface of the screen, and wherein the flat display surfaces of the different screens lie substantially in the same two-dimensional plane. The invention also relates to a use for art installations and events.

### TECHNICAL FIELD

The invention relates to a device for translation and rotation of screens in a two-dimensional plane.

In a second aspect, the invention also relates to a use for art installations and events.

### PRIOR ART

Video is regularly used at events and modern art installations. To make this video attractive, not only movement in the video is used, but also the video itself is moved. As a result, a relationship between movement in the video and the movement of the video can be suggested.

One possible way in which this can be realized is by using a large video screen with very high resolution. Examples of such large video screens are modular LED walls and projection screens with one or more video projectors. By using only a part of the resolution for displaying a video image at a time and leaving the rest, for example, black, and by changing the position of the video image from frame to frame on the video screen, the desired effect is obtained.

Another possible way is through the use of a rotatable video projector and a projection screen. This is a video projector that can be rotated about at least two axes. Rotating the video projector about one or both axes moves the video image on the projection screen.

The first known manner has the disadvantage that a large and expensive video installation is required, wherein a large part of the resolution of an LED wall or projection screen is not used, while these pixels still have to be operated. This is also not an advantageous solution from an energy-saving point of view. In addition, an LED wall is recommended for use at a greater distance, which means that this solution cannot be used in a smaller space indoors or at a short distance. The use of a projection screen with a video projector in any case requires a darkened space.

Here too, it is necessary that visitors to an event or an art exhibition stand at a greater distance, so that the visitors do not disturb the projection on the projection screen.

The second known manner has the same drawbacks that visitors have to stand at a greater distance and that the video projection is necessarily done in a darkened environment. However, the full resolution of a rotatable video projector can be used. On the other hand, it is disadvantageous that by rotating the video projector, the angle at which the video projector projects onto the projection screen constantly changes. This means that, for example, to maintain the same aspect ratio of the image, correction settings on the projector have to be changed from frame to frame, making displaying images very complex.

Other prior art devices are described in DE 10 2013 001903 and US 2020/378547.

DE10 2013 001903 describes a camera rig with a rail system with two movable clamps.

US 2020/378547 discloses a dual display stand.

The present invention aims to solve at least some of the above problems or drawbacks.

### SUMMARY OF THE INVENTION

To this end, the invention provides a device according to claim 1.

The great advantage of this device is that it comprises at least two carriages that can move along a lying rail, each carriage comprising a screen with a flat display surface and wherein the screen is rotatable about a rotary shaft perpendicular and centrally to the flat display surface of the screen.

This makes it possible to display at least two video images simultaneously and to translate these video images both parallel to the rail and to rotate them around the rotary shaft, without requiring a video screen wherein a large part of the pixels is unused, but still operated. As a result, the device is more energy efficient and requires less expensive hardware than when using a LED wall or a video projection screen according to the prior art. By using screens, high-resolution video images can be displayed on a limited surface, so that the device can also be used in a small and non-darkened space. Visitors can come watch up close to the device without disturbing a projection or without individual pixels becoming visible, as with an LED wall. The screens also have a fixed aspect ratio, so that no corrections for the aspect ratio are necessary when a video image moves.

Preferred forms of the device are set out in claims 2 to 9.

A specific preferred form of the invention relates to a device according to claim 6.

In this preferred form, the device is modular. This is advantageous for transporting the device to and from the location of an event or temporary art installation.

In a second aspect, the present invention relates to a use according to claim 15. This use results in an advantageous display of video images, wherein the device allows video images to be displayed moving in an energy efficient manner and with limited hardware, while the device can be easily transported to a location of an event or art installation. An additional advantage is that the device can also be used in smaller and non-darkened spaces, so that an event or art installation does not necessarily have to take place in a large and closed room.

### BRIEF DESCRIPTION OF THE DRAWINGS

FIG. 1A and FIG. 1B show a detail perspective view of a lying rail according to an embodiment of the present invention.

FIG. 2 shows a front view of a device according to an embodiment of the present invention.

FIG. 3 shows a detail from a rear view of a device according to an embodiment of the present invention.

### DETAILED DESCRIPTION OF THE INVENTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise”, “comprising”, “consist of”, “consisting of”, “provided with”, “include”, “including”, “contain”, “containing”, are synonyms and are inclusive or open terms that indicate the presence of what follows, and which do not exclude or prevent the presence of other components, characteristics, elements, members, steps, as known from or disclosed in the prior art.

Quoting numerical intervals by endpoints comprises all integers, fractions and/or real numbers between the endpoints, these endpoints included.

In the context of this document, ‘aspect ratio’ is the ratio between the width and length of an image. Non-limiting examples are 4:3 and 16:9 aspect ratios.

In the context of this document, movement of a video image or moving of a video image or a moving video image is a change of position where the video image is displayed in a space, as a result of which a movement of the video image is perceived. This is in contrast to a movement in a video image, wherein the position where the video image is displayed in a space does not have to change in order for movement to be perceived in the video image. An example of motion of a video image is an image of a stationary ball, wherein the position where the video image is displayed in a space changes over time, as a result of which a movement of the image of the stationary ball is perceived. An example of a movement in a video image is a video image of a moving ball, wherein a movement of the ball is perceived. It will be apparent that a moving video image can be combined with a movement in the moving video image.

In a first aspect, the invention relates to a device for translation and rotation of screens in a two-dimensional plane.

In a preferred embodiment, the device comprises a support structure to which a lying rail is attached and at least two carriages configured for moving along the lying rail in a translation direction parallel to the lying rail.

The support structure is suitable for supporting the weight of the lying rail and the at least two carriages. The support structure comprises legs, suitable for placing the support structure on a base, such as for instance a floor. Preferably, the support structure comprises one or more height-adjustable legs. This is advantageous for horizontal alignment of the support structure. The support structure extends in a longitudinal direction, parallel to the translation direction.

The lying rail extends in a longitudinal direction, parallel to the translation direction. The lying rail is preferably fixed to the support structure in a height adjustable manner. This is advantageous for horizontal alignment of the lying rail. The rail is preferably detachably fastened to the support structure by means of tensioning bolts and nuts.

A carriage comprises a sliding surface suitable for sliding along the lying rail. A sliding surface preferably comprises at least one standing flange or a groove in the direction of translation, suitable for positioning a sliding surface on the lying rail. Preferably, each carriage comprises at least one wheel, more preferably at least two wheels, configured to run along the lying rail. A wheel preferably comprises at least one standing flange, suitable for positioning a wheel on the lying rail. It will be apparent to one skilled in the art that combinations of sliding surface and wheel are also possible.

A carriage comprises a chassis to which a bracket suitable for mounting a screen is rotatably mounted. The bracket is preferably a universal bracket for a screen with a flat display surface. This is advantageous because it allows different types of screens from different manufacturers to be used in the device. Each carriage comprises a screen with a flat display surface. Non-limiting examples are an LCD screen or an OLED screen. The screen is rotatably attached to the carriage by means of the bracket. The screen is rotatable about a rotary shaft perpendicular and centrally to the flat display surface of the screen. The bracket is mounted on the rotary shaft. The display surfaces of the screens of the carriages lie substantially in the same two-dimensional plane. The rotary shaft is transverse to the lying rail. The rotary shaft is preferably lying. The two-dimensional plane is preferably a standing plane.

The device comprises a control unit, comprising a memory and a processor, configured for controlling movements of a carriage in the direction of translation along the lying rail and for controlling rotations of a screen about a rotation axis. The control unit is preferably a PLC.

The device is advantageous for simultaneously displaying at least two video images, wherein these video images are translatable both parallel to the lying rail and rotatable around the rotary shaft, without requiring a video screen wherein a large part of the pixels is unused, but still operated. As a result, the device is more energy efficient and requires less expensive hardware than when using a LED wall or a video projection screen according to the prior art. By using screens, high-resolution video images can be displayed on a limited surface, so that the device can also be used in a small and non-darkened space. Visitors to an event or art installation, for example, can come watch up close to the device, without disturbing a projection or without individual pixels, such as with an LED wall, becoming visible. The screens also have a fixed aspect ratio, so that no corrections for the aspect ratio are necessary when a video image moves.

According to an embodiment, a control unit comprises an electrical input configured to receive an external synchronization signal. The external synchronization signal is advantageous for synchronizing movements of the device with video signals sent to the screens. The external synchronization signal preferably originates from a computer or server that monitors the start of the video signals. The external video signal originates, for example, from an audio port of said computer or server.

In one embodiment, a screen has a minimum resolution corresponding to FHD (1920×1080 pixels), preferably a minimum resolution corresponding to 4K (3840×2160 pixels), even more preferably a minimum resolution corresponding to 8K (7680×4320 pixels). This is advantageous for sharp display of video images at a short distance from a visitor to an event or art installation, so that the visitor does not see individual pixels of the screen.

In one embodiment, the flat display surface of the screen has a diagonal of at least 81 cm, preferably at least 107 cm and more preferably at least 122 cm. The flat display surface of the screen has a diagonal of at most 178 cm, preferably at most 152 cm and more preferably at most 140 cm. A screen with dimensions within this range is large enough to be clearly visible to a visitor from a distance of up to at least 5 m, while the screen is small enough to have a limited weight, at most 30 kg, so that the screen exerts a limited load on a carriage.

In one embodiment, the lying rail has a rectangular cross-section in a direction transverse to the translation direction. Side walls of the lying rail are parallel to or transverse to a standing plane, the standing plane being parallel to the direction of translation.

Preferably, side walls of the lying rail lie in a plane which forms an angle of at least and at most 60°, preferably at least 40° and at most 50°, more preferably 45° with a standing plane, the standing plane being parallel to the direction of translation. Preferably, a sliding surface of a carriage comprises a concave groove in the direction of translation. Preferably, a wheel of a carriage comprises two upright flanges and a concave tread. This is advantageous for automatically aligning a wheel or sliding surface of a carriage on a centerline of the lying rail, the centerline being parallel to the direction of translation.

The lying rail is preferably formed from a profile. The profile is made of plastic, metal or another suitable material. The profile is preferably made of metal, more preferably of stainless steel.

In one embodiment, the device comprises two parallel lying rails, wherein the two parallel lying rails are positioned in a substantially lying plane. A carriage in this embodiment comprises at least two parallel sliding surfaces, wherein a first sliding surface is configured for sliding on a first of the two parallel lying rails and a second sliding surface is configured for sliding on a second of the two parallel lying rails. Alternatively, and preferably, a carriage in this embodiment comprises at least two groups of two in-line wheels, wherein a first group is configured to run on a first of the two parallel lying rails and a second group is configured to run on a second of the two parallel lying rails. This embodiment is advantageous for a stable positioning of a carriage on the lying rails. It will be apparent to one skilled in the art that combinations of sliding surface and wheel are also possible.

In an alternative embodiment, the device comprises two parallel lying rails, wherein the two parallel lying rails are positioned in a substantially standing plane. A carriage in this embodiment comprises at least two parallel sliding surfaces, wherein a first sliding surface is configured for sliding on a first of the two parallel lying rails and a second sliding surface is configured for sliding on a second of the two parallel lying rails, and wherein a carriage is held between the two parallel lying rails by means of the sliding surfaces. A sliding surface in this embodiment preferably comprises two standing flanges, wherein a first flange is positioned on a first side and a second flange on a second opposite side of a lying rail. Alternatively and preferably, a carriage in this embodiment comprises at least two groups of wheels, wherein a first group comprises at least two in-line wheels and a second group comprises at least one wheel, wherein the first group is configured to run over or under a first of the two parallel lying rails and wherein the second group is configured to run over or under a second of the two parallel lying rails, wherein the first of the two parallel lying rails is positioned lower than the second of the two parallel lying rails. A carriage is held between the two parallel lying rails by means of the two groups of wheels. It will be apparent to one skilled in the art that combinations of sliding surface and wheel are also possible.

In a preferred embodiment, a carriage comprises a first motor configured to translate the carriage along the lying rail in the direction of translation and the carriage comprises a second motor configured to rotate the screen about the rotary shaft. The motors are preferably electric motors. A carriage comprising a first and a second motor is advantageous because it allows a screen to be translated and rotated in a two-dimensional plane, without requiring mechanical transmissions from motors, which are fixedly mounted on the support structure of the device, to the carriage and to the rotary shaft on the carriage are required. Preferably, a carriage comprises at least one wheel configured to convert a rotational movement of the first motor to a translational movement of the carriage. The first motor drives the at least one wheel directly or via a reduction gear and/or mechanical transmission. The second motor drives the rotary shaft directly or via a reduction gear and/or mechanical transmission.

In a further embodiment, the motors of a carriage are servo motors with an integrated encoder. The integrated encoder is an incremental encoder or an absolute encoder. An incremental encoder is configured to generate pulses in proportion to rotation of a motor shaft, wherein the number of pulses determines an angle through which a motor shaft is rotated. Preferably, the incremental encoder is configured to give a signal at each rotation through 360° from a predetermined starting position of a motor shaft. This is particularly advantageous when determining an angular position of a screen about the rotary shaft. An absolute encoder is configured to provide signals, wherein a signal is dependent on an angle through which a motor shaft is rotated. The use of servo motors with an integrated encoder is advantageous for determining a position of a carriage, wherein by determining an angle through which a motor shaft is rotated, a distance over which a carriage has been translated or an angle through which a screen is rotated can be calculated. In this way, the position of a screen in a two-dimensional plane can be continuously determined from a known starting position, without the position having to be measured by means of sensors, such as for instance a laser distance meter. By using a servo motor with an integrated encoder, a screen can be accurately rotated around the rotary shaft. The accuracy of rotation of a screen about the rotary shaft is at least 1°, preferably at least 0.5°, more preferably at least 0.05° and even more preferably at least 0.01°.

In a preferred embodiment, the motors of a carriage are servo motors with an integrated absolute encoder, as previously described.

In one embodiment, the device comprises a rack, wherein the rack extends in the direction of translation from a first end to a second end of the device. The rack preferably comprises a plurality of detachable sections. A carriage comprises at least one gearwheel, configured to convert a rotational movement of the first motor to a translational movement of the carriage. A rack is advantageous for translating a carriage over a lying rail because it is avoided that a wheel configured to convert a rotational movement of the first motor to a translational movement of the carriage slips on a lying rail. This is particularly advantageous in combination with a previously described embodiment in which a carriage comprises servo motors with an integrated encoder, in order to avoid that a position of a screen in a two-dimensional space is incorrectly calculated due to slip and a screen is translated imprecisely in the direction of translation. By combining a servo motor with an integrated encoder and a rack, a screen can be accurately translated in the direction of translation. The accuracy of translation of a screen in the direction of translation is at least 1 mm, preferably at least 0.5 mm, more preferably at least mm and even more preferably at least 0.01 mm.

This embodiment can be advantageously combined with previously described embodiments with two parallel lying rails. A rack can also replace one of the two parallel rails in the previously described embodiments.

In an alternative embodiment, the device comprises a toothed belt, wherein the toothed belt is tensioned in the direction of translation from a first end to a second end of the device. A carriage comprises at least one gearwheel, configured to convert a rotational movement of the first motor to a translational movement of the carriage. A carriage preferably comprises, in addition to a gearwheel, at least one idler pulley configured for tensioning the toothed belt on the gearwheel. A toothed belt is advantageous for translating a carriage over a lying rail because it is avoided that a wheel configured to convert a rotational movement of the first motor to a translational movement of the carriage slips on a lying rail. This is particularly advantageous in combination with a previously described embodiment in which a carriage comprises servo motors with an integrated encoder, in order to avoid that a position of a screen in a two-dimensional space is incorrectly calculated due to slip and a screen is translated imprecisely in the direction of translation. By combining a servo motor with an integrated encoder and a toothed belt, a screen can be accurately translated in the direction of translation. The accuracy of translation of a screen in the direction of translation is at least 1 mm, preferably at least 0.5 mm, more preferably at least 0.05 mm and even more preferably at least mm. A toothed belt is also advantageous compared to a rack, as in a previously described embodiment, in that a carriage produces less noise when translated.

This embodiment can be advantageously combined with previously described embodiments with two parallel lying rails. A toothed belt can also replace one of the two parallel rails in the previously described embodiments.

In a further embodiment, the toothed belt is a self-centering toothed belt. A self-centering toothed belt is advantageous for automatically positioning a gearwheel on a centerline of the self-centering toothed belt, thereby preventing a gearwheel from running off the self-centering toothed belt. The centerline has a direction parallel to the translation direction.

In a preferred embodiment, the bracket, suitable for mounting a screen, is adjustable in position in a direction along the longitudinal direction of the rotation axis and/or in two orthogonal directions transverse to the rotation axis. The bracket is adjustable over a distance of at least 1 mm, preferably at least 5 mm, more preferably at least 10 mm and even more preferably at least 15 mm. This is advantageous for aligning screens of different carriages so that the screens lie substantially in the same two-dimensional plane.

In a preferred embodiment, the device comprises a sensor configured to detect a starting position of a carriage in the direction of translation. For example, the sensor may be a mechanical or magnetic contact, which is closed when a carriage is positioned at a predetermined position on the lying rail. The sensor is advantageous for calibration of the device, wherein a carriage is translated along the lying rail until the sensor detects that a carriage is positioned at a starting position. The starting position of the said carriage is now known. This is particularly advantageous in combination with previously described embodiments wherein a position of a screen in a two-dimensional plane is determined from a known starting position. The device may comprise a single sensor for all carriages. The device may comprise one sensor per carriage.

In a further embodiment, the device comprises a sensor configured to detect an end position of a carriage in the direction of translation. The sensor is analogous to a sensor for detecting a starting position as in a previously described embodiment. Starting position and end position in this embodiment are located near opposite ends of the lying rail. Starting position and end position determine extreme positions for a carriage on the lying rail. This embodiment is advantageous in combination with a previously described embodiment wherein a carriage comprises a servo motor with integrated encoders. By detecting the starting position and the end position, a number of revolutions of the servo motor between these extreme positions can be determined, whereby a distance over which a carriage translates per revolution can be calculated and a carriage as previously described can be accurately positioned by determining revolutions of a motor shaft. This is particularly advantageous in combination with previously described embodiments with a toothed belt. Due to a difference in tension in the belt, the distance over which a carriage translates per revolution can deviate from a theoretically expected distance.

In a preferred embodiment, the device comprises a safety system, wherein the safety system is configured to measure torques and rotational speeds of motors of the carriages. A lower rotational speed of a motor compared to a predetermined rotational speed or an increase in the motor torque at a constantly set rotational speed of a motor indicates a blocking of a carriage or a screen, for example due to contact with a visitor to an event or an art installation or by a collision between two carriages or screens. When such a deviation in rotational speed or torque is measured, a translation and/or rotation of a screen is immediately stopped, so that for instance a visitor cannot be clamped between moving parts of the device and as a result of which carriages and screens are not or hardly damaged.

In a preferred embodiment, the device comprises a scanning system configured for scanning the proximity of persons. This is advantageous for stopping translation and/or rotation of screens when, for example, visitors to an event or art installation come too close to the device and can become wedged between moving parts of the device.

An example of a suitable scanning system is a light curtain. Preferably, the light curtain forms a standing plane, at a distance of at least 50 cm from moving parts of the device and on one side of the display surfaces of the screens. The distance is preferably at least 75 cm, more preferably at least 100 cm, even more preferably at least 125 cm and even more preferably at least 150 cm.

In a preferred embodiment, a carriage comprises an energy chain. The energy chain is fixedly attached to the carriage at a first end. A second end of the energy chain is rotatable about the rotary shaft. The energy chain is configured for coiling around the rotary shaft. The energy chain is preferably configured for concentric coiling around the rotary shaft. The second end of the energy chain is preferably attached near the rotary shaft. For example, the second end is attached to the bracket of the carriage. The energy chain is preferably a cable chain. The energy chain is advantageous for guiding at least a power cable and a video cable from the carriage to a screen which is rotatably mounted on the carriage. Due to the energy chain, the power cable and video cable are not damaged or entangled during rotation of the screen. The power cable and video cable can be routed invisibly to the screen along the rotary shaft.

In a preferred embodiment, a carriage comprises a U-shaped energy chain, wherein one end of a first leg of the U-shaped energy chain is fixedly attached to the carriage and wherein one end of a second leg of the U-shaped energy chain is fixedly or detachably attached to the support structure. The two legs of the U-shaped energy chain are substantially parallel to the translation direction. The energy chain is preferably a cable chain. The energy chain is advantageous for guiding at least a power supply cable and communication cable to a carriage and a power supply cable and a video cable to a screen which is rotatably mounted on the carriage. The power cable to the screen and the power cable to the carriage can be one power cable. Due to the energy chain, the cables are not damaged during a movement of the carriage in the direction of translation. The energy chain is configured so that when the carriage moves in the direction of translation, the first leg of the U-shaped energy chain lengthens, and the second leg shortens, or the first leg of the U-shaped energy chain shortens, and the second leg lengthens.

In a preferred embodiment, the device is modular. Each module of the device comprises a carriage and a part of the support structure and the lying rail. Each module comprises a control unit. This is advantageous over a single central control unit for the entire device because of cable reduction, in that all control cables for motors of a carriage are connected to the control unit contained in the carriage, rather than to a central control unit. The part of the lying rail of a module is releasably coupled to the part of the lying rail of adjacent modules. Preferably, each module comprises an equal length of lying rail. This embodiment is advantageous for transporting the device to and from a location of an event or temporary art installation.

In a preferred embodiment, the lying rail comprises a sectional plane at a transition between adjacent modules. The lying rail has a rectangular cross-section in a direction transverse to the translation direction, as in a previously described embodiment. The sectional plane comprises four vertices. Three vertices correspond to three vertices of the rectangular cross-section of the lying rail. The fourth vertex of the sectional plane corresponds to the fourth vertex of the rectangular cross-section, shifted in the direction of translation. The fourth vertex is shifted by a distance of at least 5 mm, preferably at least 10 mm, more preferably at least 15 mm. The sectional plane forms a finger joint between parts of lying rails of adjacent modules. A finger joint is advantageous for an automatic alignment of said parts.

Preferably, parts of lying rails of adjacent modules comprise eight tensioning bolts suitable for connecting said parts together and two adjusting bolts for adjusting mutual positions of said parts according to two orthogonal directions, transverse to the direction of translation.

In a preferred embodiment, the device comprises an even number of modules. The ends of the legs of the U-shaped energy chains, as in a previously described embodiment, are directed towards a center of the device according to the direction of translation. The center of the device means that the same number of modules are located on both sides of the center along the translation direction. The end of the first leg of a U-shaped energy chain of a carriage is attached to the carriage higher up than the end of the first leg of a U-shaped energy chain of a carriage closer to said center. The ends of the second legs are fixedly or detachably attached to the support structure at the same height. Alternatively, the end of the second leg of a U-shaped energy chain of a carriage is attached lower to the support structure than the end of the second leg of a U-shaped energy chain of a carriage closer to said center. This is advantageous if two carriages located on the same side in the direction of translation from the center move towards each other, because the U-shaped energy chain, the first end of which is attached lower to the carriage, can move in the U-shaped energy chain, the first end of which is attached higher up on the carriage.

In a preferred embodiment, adjacent modules are electrically and communicatively coupled to each other. Power is routed to a first module. Possible control signals from an external control platform, such as for instance computers and/or servers, are passed to a control unit of the first module. From the first module, the power supply is serially coupled from module to module using cables. From the control unit of the first module, control signals are serially coupled from control unit to control unit by means of cables. Preferably, the control signals comprise the external synchronization signal as in a previously described embodiment. This embodiment is advantageous for limiting cables to modules of the device and is also advantageous for a simple construction and dismantling of the device.

In a second aspect, the invention relates to a use of a device according to the first aspect for art installations and events. The art installation may or may not be temporary.

This use results in an advantageous display of video images, wherein the device allows video images to be displayed moving in an energy efficient manner and with limited hardware, while the device can be easily transported to a location of an event or art installation. An additional advantage is that the device can also be used in smaller and non-darkened spaces, so that an event or art installation does not necessarily have to take place in a large and closed room.

In what follows, the invention is described by way of non-limiting figures illustrating the invention, and which are not intended to and should not be interpreted as limiting the scope of the invention.

### DETAILED DESCRIPTION OF THE DRAWINGS

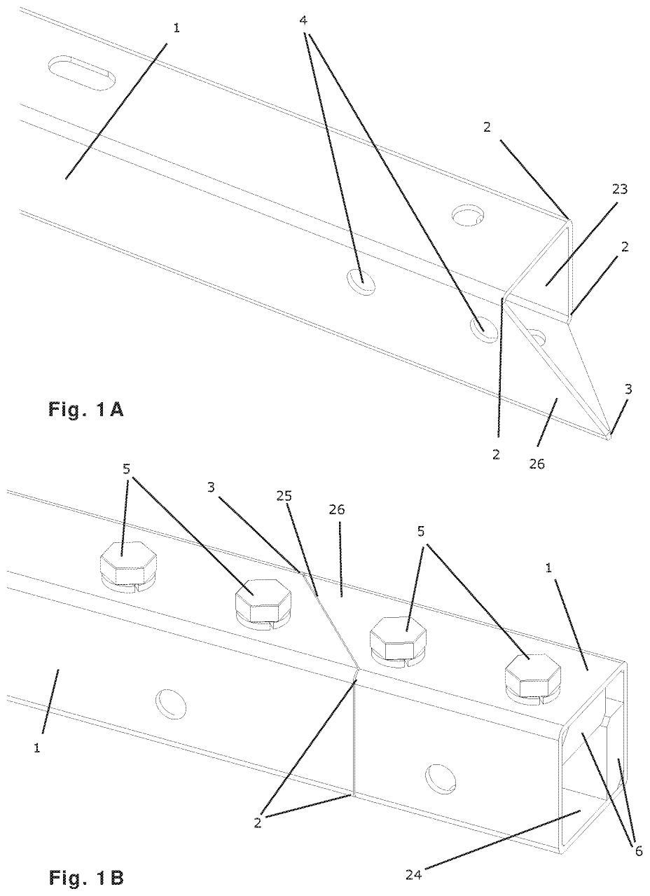

FIG. 1A and FIG. 113 show a detail perspective view of a lying rail according to an embodiment of the present invention.

FIG. 1A shows a sectional plane (23) of the lying rail (1). The lying rail (1) has a rectangular cross-section (24), in particular a square cross-section (24). The sectional plane (23) comprises four vertices (2) and (3). Three vertices (2) correspond to vertices of a square cross-section (24). The fourth vertex (3) corresponds to the fourth vertex of a square cross-section (24), shifted in the direction of translation. The translation direction is parallel to the longitudinal direction of the lying rail (1). The lying rail (1) comprises fixing holes (4) for fastening parts of the lying rails (1) of adjacent modules to each other.

FIG. 1B shows a finger joint between parts of lying rails (1) of adjacent modules.

Note that the lying rail (1) from FIG. 1A is oriented differently in FIG. 1B and a cross-section (24) is drawn in FIG. 1B, so that blocks (6) in the lying rail (1) are visible. The finger joint (25) comprises a tooth (26), at the level of the vertex (3). A finger joint (26) is advantageous for automatic alignment of parts of the lying rail (1). The parts of lying rails (1) are fixed to each other by means of tensioning bolts (5) that are screwed into blocks (6) through fixing holes (4). The blocks (6) have threaded holes at the level of the fixing holes (4). The blocks (6) extend transversely across the sectional plane (25) of the lying rail (1).

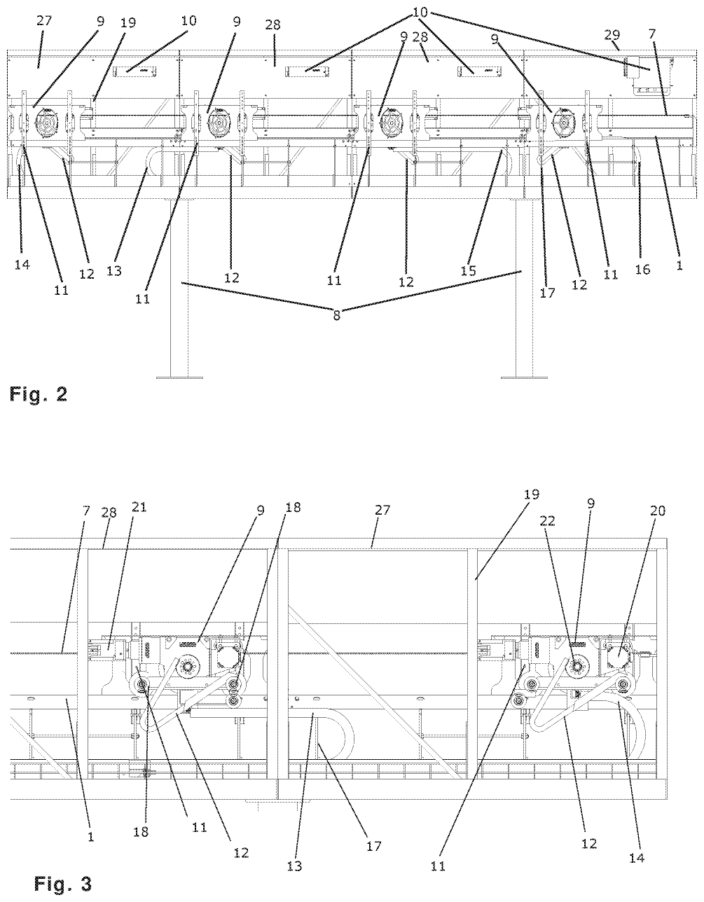

FIG. 2 shows a front view of a device according to an embodiment of the present invention.

The device comprises a support structure (19). The support structure (19) is a framework. The support structure (19) extends in a longitudinal direction, parallel to the translation direction. A lying rail (1) is attached to the support structure (19). The lying rail (1) extends in a longitudinal direction, parallel to the translation direction. The longitudinal direction of the support structure (19) and the lying rail (1) is the same. A toothed belt (7) extends in the direction of translation from a first end of the device to a second end. The lying rail (1) is fixed to the support structure (19) in a height adjustable manner by means of standing slats (17). This is advantageous for horizontal alignment of the lying rail (1). The support structure (19) comprises legs (8), suitable for placing the support structure (19) on a base.

The device is modular. The device comprises four modules (27), (28) and (29). The two modules in the middle (28) are identical. At ends in the direction of translation, there are unique modules (27) and (28). Each module (27), (28) and (29) comprises a control unit (10). Power is connected at the module (27). Power is serially coupled from module (27) to the left module (28), then to the right module (28) and finally to the module (29). Control signals from an external control platform are coupled to the control unit (10) of module (27). The control signals are sent serially from the control unit (10) of module (27) to the control unit (10) of the left module (28), then to the control unit (10) of the right module (28) and finally to the control unit (10) of module (29).

Each module (27), (28) and (29) comprises a carriage (9). A bracket (11) is mounted rotatably about a rotation axis (22) on a carriage (9). The bracket (11) comprises a plate on which two parallel rods with fixing holes are mounted. The bracket (11) is a universal bracket suitable for mounting screens with a flat display surface. The screens are not shown in FIG. 2. A carriage (9) comprises an energy chain (12). The energy chain (12) is fixedly attached to the carriage (9) at a first end. A second end of the energy chain (12) is rotatable about the rotary shaft (22). The energy chain (12) is configured for concentric coiling around the rotary shaft (22). The second end of the energy chain (12) is attached to the bracket (11) near the rotation axis (22).

A carriage (9) comprises a U-shaped energy chain (13), (14), (15) or (16). One end of a first leg of the U-shaped energy chain (13), (14), (15) or (16) is fixedly attached to the carriage (9). One end of a second leg of the U-shaped energy chains (13), (14), (15) and (16) is fixedly or detachably attached to the support structure (19). The two legs of the U-shaped energy chains (13), (14), (15) and (16) are substantially parallel to the translation direction. The energy chains (13), (14), (15) and (16) are configured so that when a carriage (9) moves in the direction of translation, the first leg of a U-shaped energy chain (13), (14), (15) or (16) lengthens and the second leg shortens or the first leg of the U-shaped energy chain (13), (14), (15) or (16) shortens and the second leg lengthens. The ends of the legs of the U-shaped energy chains (13), (14), (15) and (16) are directed towards a center of the device according to the direction of translation. By the center of the device is meant a transition between the two modules (28). The end of the first leg of U-shaped energy chain (14) is attached to a carriage (9) higher than the end of the first leg of U-shaped energy chain (13). The end of the first leg of U-shaped energy chain (16) is attached to a carriage (9) higher than the end of the first leg of U-shaped energy chain (15). The ends of the second legs of energy chains (13), (14), (15) and (16) are attached at the same height to the support structure (19). This is advantageous because when the carriage (9), to which the U-shaped energy chain (13) is attached, moves in the direction of the carriage (9), to which the U-shaped energy chain (14) is attached, the U-shaped shaped energy chain (13) can move in the U-shaped energy chain (14).

FIG. 3 shows a detail from a rear view of a device according to an embodiment of the present invention.

The device in FIG. 3 is a detail of the device in FIG. 2. The device is viewed from the rear.

A carriage (9) comprises two wheels (18) configured for moving along the lying rail (1) in the direction of translation. A carriage (9) comprises a first motor (20), configured to translate the carriage (9) along the lying rail (1) in the direction of translation. The motor (20) drives a gearwheel which engages in the toothed belt (7). The motor (20) is connected to the gearwheel via a reduction gear. A carriage (9) comprises a second motor (21), configured to rotate a screen about the rotary shaft (22). The screen is attached to the bracket (11). The bracket (11) is located at the front of the device. The screen is not shown in FIG. 3). The motor (21) is connected to the rotary shaft (22) via a reduction gear and a mechanical transmission. The motors (20) and (21) comprise an integrated encoder.

1. A device for translation and rotation of screens in a two-dimensional plane, comprising a support structure to which a lying rail is attached and at least two carriages, configured for moving along the lying rail in a translation direction parallel to the lying rail, wherein each carriage comprises a screen with a flat display surface, wherein the screen is rotatable about a rotary shaft perpendicular and centrally to the flat display surface of the screen, and wherein the flat display surfaces of the screens of the carriages lie substantially in the same two-dimensional plane.

2. The device according to claim 1, wherein a carriage comprises a first motor configured to translate the carriage along the lying rail in the direction of translation, and in that the carriage comprises a second motor configured to rotate the screen about the rotary shaft.

3. The device according to claim 2, wherein the motors of a carriage are servo motors with an integrated encoder.

4. The device according to claim 1, wherein a carriage comprises an energy chain, wherein the energy chain is fixedly attached to the carriage at a first end, wherein a second end of the energy chain is rotatable about the rotary shaft, and wherein the energy chain is configured for coiling around the rotary shaft.

5. The device according to claim 1, wherein a carriage comprises a U-shaped energy chain, wherein one end of a first leg of the U-shaped energy chain is fixedly attached to the carriage, wherein one end of a second leg of the U-shaped energy chain is fixedly or detachably attached to the support structure, and wherein both legs of the U-shaped energy chain are substantially parallel to the direction of translation.

6. The device according to claim 1, wherein the device is modular, wherein each module comprises a carriage and a part of the support structure and the lying rail, wherein each module comprises a control unit configured to control the carriage and wherein the part of the lying rail of a module is releasably coupled to the part of the lying rail of adjacent modules.

7. The device according to claim 6, wherein the lying rail has a rectangular cross-section in a direction transverse to the translation direction, wherein the lying rail comprises a sectional plane at a transition between adjacent modules, wherein the sectional plane comprises four vertices, wherein three vertices correspond to three vertices of the rectangular cross-section and wherein the fourth vertex of the sectional plane corresponds to the fourth vertex of the rectangular cross-section, shifted in the direction of translation.

8. The device for translation and rotation of screens in a two-dimensional plane, comprising a support structure to which a lying rail is attached and at least two carriages, configured for moving along the lying rail in a translation direction parallel to the lying rail, wherein each carriage comprises a screen with a flat display surface, wherein the screen is rotatable about a rotary shaft perpendicular and centrally to the flat display surface of the screen, and wherein the flat display surfaces of the screens of the carriages lie substantially in the same two-dimensional plane;
wherein a carriage comprises a U-shaped energy chain, wherein one end of a first leg of the U-shaped energy chain is fixedly attached to the carriage, wherein one end of a second leg of the U-shaped energy chain is fixedly or detachably attached to the support structure, and wherein both legs of the U-shaped energy chain are substantially parallel to the direction of translation;
and according to claim 6, wherein the device comprises an even number of modules, wherein the ends of the legs of the U-shaped energy chains are directed towards a center of the device according to the direction of translation, and wherein the end of the first leg of a U-shaped energy chain of a carriage is attached to the carriage higher up than the end of the first leg of a U-shaped energy chain of a carriage closer to said center.

9. The device according to claim 6, wherein adjacent modules are electrically and communicatively coupled to each other.

10. The device according to claim 1, wherein the device comprises a toothed belt, wherein the toothed belt is tensioned in the direction of translation from a first end to a second end of the device.

11. The device according to claim 1, wherein a carriage comprises a bracket suitable for mounting a screen, wherein the bracket is mounted on the rotary shaft, and wherein the bracket is adjustable in position in a direction along the longitudinal direction of the rotary shaft and in two orthogonal directions transverse to the rotary shaft.

12. The device according to claim 1, wherein the device comprises a sensor, configured to determine a starting position of a carriage according to the direction of translation.

13. The device according to claim 1, wherein the device comprises a safety system, wherein the safety system is configured to measure torques and rotational speeds of motors of the carriages.

14. The device according to claim 1, wherein the device comprises a scanning system, configured for scanning the proximity of persons.

15. Use of the device according to claim 1 for art installations and events.
